(19) United States
(12) Patent Application Publication
(10) Pub. No.: US 2010/0287589 A1
(43) Pub. Date: Nov. 11, 2010

(54) REAL-TIME GROUP DRIVEN AUTOMATED MEDIA CONTENT SELECTION

(75) Inventor: Todd Stiers, Berkeley, CA (US)

Correspondence Address: Weaver Austin Villeneuve & Sampson LLP, P.O. BOX 70250, OAKLAND, CA, 94612-0250, US

(73) Assignee: MobiTV, Inc., Emeryville, CA (US)

(21) Appl. No.: 12/435,925

(22) Filed: May 5, 2009

(51) Int. Cl. H04N 5/445; H04N 7/173

(52) U.S. Cl. 725/46; 725/97

(57) ABSTRACT

Mechanisms are provided for automatically selecting media content for presentation on a device such as a mobile device. An application and content provider compiles real-time most watched program information by determining viewing patterns associated with various individuals and groups. Channels and video clips requested most frequently are automatically displayed to a user. In some examples, the most popular programming associated with a particular group of friends, a particular user location, an interest set, or a demographic profile is automatically displayed to a user. In another example, the content with the largest rate of increase in viewership is automatically displayed to the user.

### DESCRIPTION OF RELATED ART

The present disclosure relates to media content selection. In some examples, the techniques of the present disclosure provide mechanisms for automatically selecting media content.

Electronic program guides provide users with information to allow video content selection. Some electronic program guides provide hundreds or thousands of options including numerous channels and video on demand clips. However, mechanisms for sorting through the options and selecting video content are limited. Consequently, the techniques and mechanisms of the present invention provide improved mechanisms for automatically selecting media content for a user.

### OVERVIEW

Mechanisms are provided for automatically selecting media content for presentation on a device such as a mobile device. An application and content provider compiles real-time most watched program information by determining viewing patterns associated with various individuals and groups. Channels and video clips requested most frequently are automatically displayed to a user. In some examples, the most popular programming associated with a particular group of friends, a particular user location, an interest set, or a demographic profile is automatically displayed to a user. In another example, the content with the largest rate of increase in viewership is automatically displayed to the user.

These and other features of the present invention will be presented in more detail in the following specification of the invention and the accompanying figures, which illustrate by way of example the principles of the invention.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates a particular example of a network that can use the techniques and mechanisms of the present invention.

FIG. 2 illustrates a particular example of a content delivery system.

FIG. 3 illustrates a particular example of a program guide.

FIG. 4 illustrates another particular example of a program guide.

FIG. 5 illustrates a particular example of a device guide request sequence.

FIG. 6 illustrates a particular example of server processing for generating a real-time most watched guide.

FIG. 7 illustrates a particular example of server processing for providing a most watched guide.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular devices such as mobile devices. However, it should be noted that the techniques and mechanisms of the present invention can be used with a variety of devices including general computing devices. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a processor is used in a variety of contexts. However, it will be appreciated that multiple processors can also be used while remaining within the scope of the present invention unless otherwise noted. Furthermore, the techniques and mechanisms of the present invention will sometimes describe two entities as being connected. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Selecting video content on a device such as a mobile phone or a portable computing device can often be inefficient. In many instances, subscription packages provide hundreds of channels and thousands of video on demand clips. It is difficult for a user to identify interesting or exciting content. In some instances, electronic program guides can organize content by category, such as dramas, sports, or movies and provide the content in numerically ordered channel listings. In some other instances, popularly rated programs or award winning content is flagged for a user. Electronic program guides may also be filtered. In some examples, non-family oriented programming is filtered based on user selection.

However, providing thousands of channels and video clips to a user results in a large of amount of information and choices. This information may be shown in a part of a display or condensed onto a device screen. The information may scroll automatically or may scroll after user input. In many instances, channels and video clips may be listed in numerical order or alphabetical order. In either case, it takes a tremendous amount of time to sift through content, and even after viewing the titles, a user still may have insufficient information to make an intelligent selection.

According to various embodiments, various mechanisms provide a content listing ordered based on real-time most watched data. For example, a program currently being watched by the most viewers is listed first, while the next most watched program is listed second. This program listing is provided based on real-time viewership information. In many applications, acquiring this information is not possible for the generation of program guides. For example, ratings and popularity information for shows is often compiled well after a show has finished airing. However, the techniques and mechanisms of the present invention provide an architecture that allows the generation of real-time most watched program guides.

According to various embodiments, users send requests for video stream to content servers. These content servers and associated processing systems compile real-time viewing information. At a particular time period, a content server may receive hundreds of thousands of requests for a particular sporting event on one channel, and possibly only tens of thousands of requests for a particular movie on another channel. A server can compile all of this information to reorder a conventional program guide. The viewership information can be continuously compiled to continuously generate real-time most watched program guides. The real-time most watched program guide or a portion of the real-time most watched program guide can be provided to a user at any time.

In many instances, the real-time most watched program guide is provided to a user upon request. In another example, a content server may maintain information about the rate of change in viewership for particular channels. For example, a large number of viewers may switch to a news program at a particular time frame. The content monitors the rate of change in viewership for the news program. In some examples, the content server generates a program guide ranking channels based on rate of change in viewership. In some examples, content is automatically selected or automatically provided based on first and second derivatives of viewership. For example, the channels with the greatest increase in viewership may be listed first.

According to various embodiments, a user may configure a profile to allow automatic selection of media content based on most watched characteristics. Rather than requiring the user to continue to make choices, various embodiments provide users with the option of following the mob in real-time. In particular embodiments, the user makes a selection to simply subscribe to what the vast majority of other users are doing, and to allow the media session to follow. If the mob moves from news to music, the user's device as a member of the mob follows. In another example, a user may configure a profile to watch content having the largest growth rate in viewership.

According to particular embodiments, real-time content discovery is based on current activity of all the users on the system. Especially for real-time events or news, a member of the mob can avoid being left behind and finding out after the fact. Also, the need for a user to change channels goes away. Allowing the group to choose the channel allows a user to lurk without further action. In some embodiments, a user may elect to follow a mob for a particular geographic location, or a mob matching particular user demographic characteristics. In other examples, a user may elect to follow members of a particular interest group, or may follow what a group of colleagues is watching. According to various embodiments, a server sends specific programs to a user without receiving any channel or content request from the user. In some embodiments, once a particular program is selected for a user, no program changes are made for a predetermined period of time so that constant programming changes do not occur if mob viewing patterns or viewership growth rates are fluctuating.

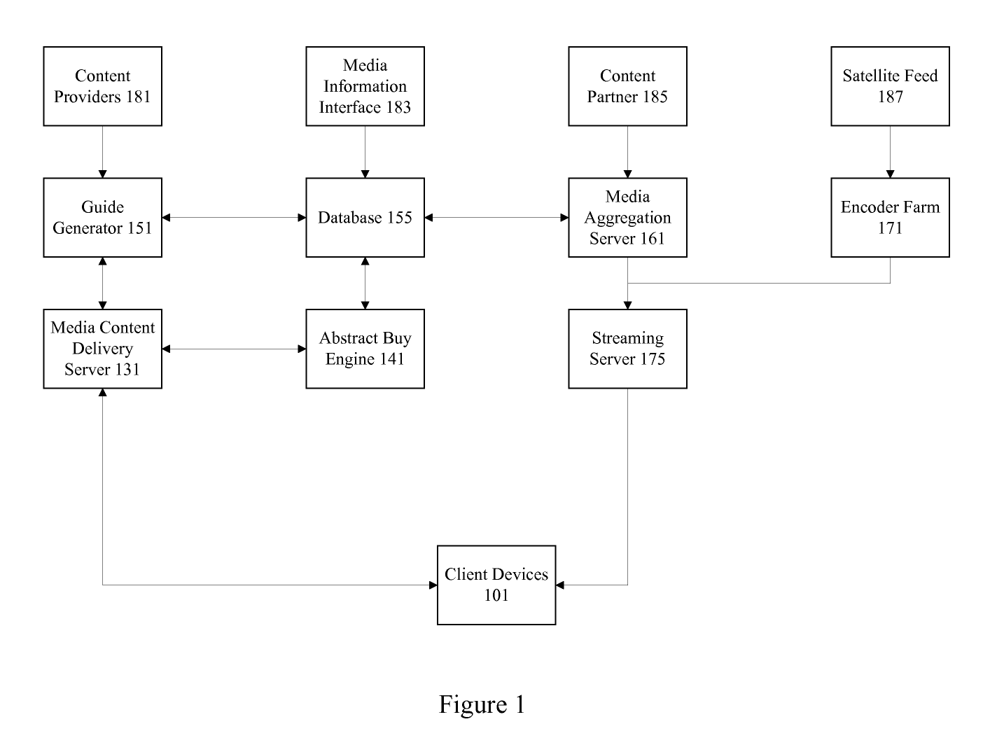

FIG. 1 is a diagrammatic representation showing one example of a network that can use the techniques of the present invention. According to various embodiments, media content is provided from a number of different sources 185. Media content may be provided from film libraries, cable companies, movie and television studios, commercial and business users, etc. and maintained at a media aggregation server 161. Any mechanism for obtaining media content from a large number of sources in order to provide the media content to mobile devices in live broadcast streams is referred to herein as a media content aggregation server. The media content aggregation server 161 may be clusters of servers located in different data centers. According to various embodiments, content provided to a media aggregation server 161 is provided in a variety of different encoding formats with numerous video and audio codecs. Media content may also be provided via satellite feed 157.

An encoder farm 171 is associated with the satellite feed 187 and can also be associated with media aggregation server 161. The encoder farm 171 can be used to process media content from satellite feed 187 as well as possibly from media aggregation server 161 into potentially numerous encoding formats. According to various embodiments, file formats include open standards MPEG-1 (ISO/IEC 11172), MPEG-2 (ISO/IEC 13818-2), MPEG-4 (ISO/IEC 14496), as well as proprietary formats QuickTime™, ActiveMovie™, and RealVideo™. Some example video codecs used to encode the files include MPEG-4, H.263, and H.264. Some example audio codecs include Qualcomm Purevoice™ (QCELP), The Adaptive Multi-Narrow Band (AMR-NB), Advanced Audio coding (AAC), and AACPlus. The media content may also be encoded to support a variety of data rates. The media content from media aggregation server 161 and encoder farm 171 is provided as live media to a streaming server 175. In one example, the streaming server is a Real Time Streaming Protocol (RTSP) server 175. Media streams are broadcast live from an RTSP server 175 to individual client devices 101. A variety of protocols can be used to send data to client devices.

Possible client devices 101 include personal digital assistants (PDAs), cellular phones, personal computing devices, personal computers etc. According to various embodiments, the client devices are connected to a cellular network run by a cellular service provider. IN other examples, the client devices are connected to an Internet Protocol (IP) network. Alternatively, the client device can be connected to a wireless local area network (WLAN) or some other wireless network. Live media streams provided over RTSP are carried and/or encapsulated on one of a variety of wireless networks.

The client devices are also connected over a wireless network to a media content delivery server 131. The media content delivery server 131 is configured to allow a client device 101 to perform functions associated with accessing live media streams. For example, the media content delivery server allows a user to create an account, perform session identifier assignment, subscribe to various channels, log on, access program guide information, obtain information about media content, etc. According to various embodiments, the media content delivery server does not deliver the actual media stream, but merely provides mechanisms for performing operations associated with accessing media. In other implementations, it is possible that the media content delivery server also provides media clips, files, and streams. The media content delivery server is associated with a guide generator 151. The guide generator 151 obtains information from disparate sources including content providers 181 and media information sources 183. The guide generator 151 provides program guides to database 155 as well as to media content delivery server 131 to provide to client devices 101.

According to various embodiments, the guide generator 151 obtains viewership information from individual client devices. In particular embodiments, the guide generation 151 compiles viewership information in real-time in order to generate a most-watched program guide listing most popular programs first and least popular programs last. The client device 101 can request program guide information and the most-watched program guide can be provided to the client device 101 to allow efficient selection of video content. According to various embodiments, guide generator 151 is connected to a media content delivery server 131 that is also associated with an abstract buy engine 141. The abstract buy engine 141 maintains subscription information associated with various client devices 101. For example, the abstract buy engine 141 tracks purchases of premium packages.

The media content delivery server 131 and the client devices 101 communicate using requests and responses. For example, the client device 101 can send a request to media content delivery server 131 for a subscription to premium content. According to various embodiments, the abstract buy engine 141 tracks the subscription request and the media content delivery server 131 provides a key to the client device 101 to allow it to decode live streamed media content. Similarly, the client device 101 can send a request to a media content delivery server 131 for a most-watched program guide for its particular program package. The media content delivery server 131 obtains the guide data from the guide generator 151 and associated database 155 and provides appropriate guide information to the client device 101.

Although the various devices such as the guide generator 151, database 155, media aggregation server 161, etc. are shown as separate entities, it should be appreciated that various devices may be incorporated onto a single server. Alternatively, each device may be embodied in multiple servers or clusters of servers. According to various embodiments, the guide generator 151, database 155, media aggregation server 161, encoder farm 171, media content delivery server 131, abstract buy engine 141, and streaming server 175 are included in an entity referred to herein as a media content delivery system.

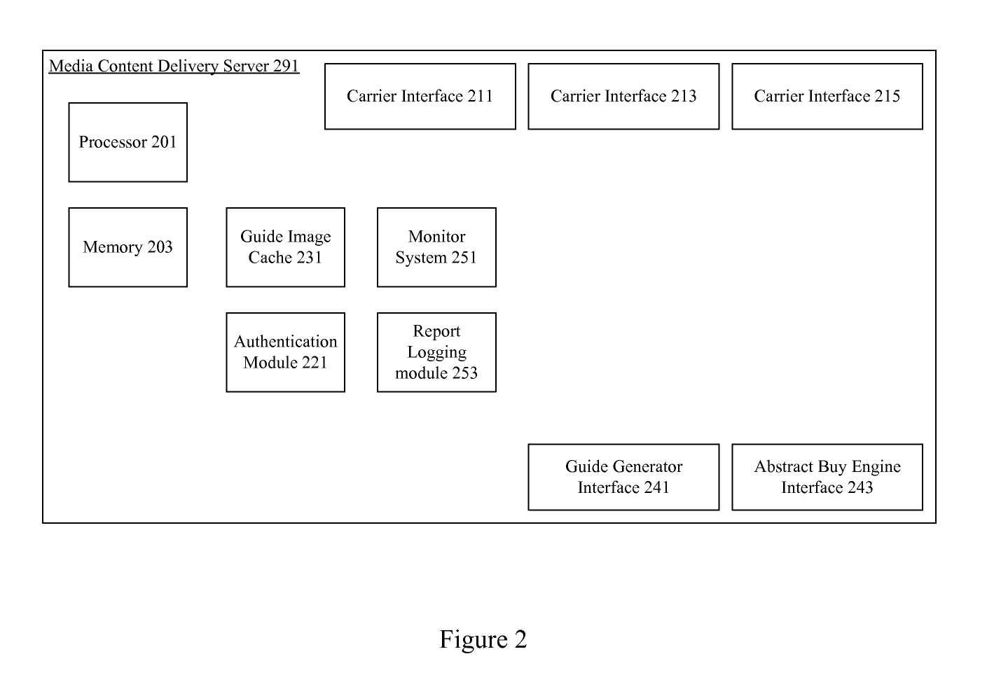

FIG. 2 is a diagrammatic representation showing one example of a media content delivery server 291. According to various embodiments, the media content delivery server 291 includes a processor 201, memory 203, and a number of interfaces. In some examples, the interfaces include a guide generator interface 241 allowing the media content delivery server 291 to obtain program guide information. The media content delivery server 291 also can include a program guide cache 231 configured to store program guide information and data associated with various channels. The media content delivery server 291 can also maintain static information such as icons and menu pages. The interfaces also include a carrier interface 211 allowing operation with mobile devices such as cellular phones operating in a particular cellular network. The carrier interface allows a carrier vending system to update subscriptions. Carrier interfaces 213 and 215 allow operation with mobile devices operating in other wireless networks. An abstract buy engine interface 243 provides communication with an abstract buy engine that maintains subscription information.

An authentication module 221 verifies the identity of mobile devices. A logging and report generation module 253 tracks mobile device requests and associated responses. A monitor system 251 allows an administrator to view usage patterns and system availability. According to various embodiments, the media content delivery server 291 handles requests and responses for media content related transactions while a separate streaming server provides the actual media streams. In some instances, a media content delivery server 291 may also have access to a streaming server or operate as a proxy for a streaming server. But in other instances, a media content delivery server 291 does not need to have any interface to a streaming server. In typical instances, however, the media content delivery server 291 also provides some media streams. The media content delivery server 291 can also be configured to provide media clips and files to a user in a manner that supplements a streaming server.

Although a particular media content delivery server 291 is described, it should be recognized that a variety of alternative configurations are possible. For example, some modules such as a report and logging module 253 and a monitor 251 may not be needed on every server. Alternatively, the modules may be implemented on another device connected to the server. In another example, the server 291 may not include an interface to an abstract buy engine and may in fact include the abstract buy engine itself. A variety of configurations are possible.

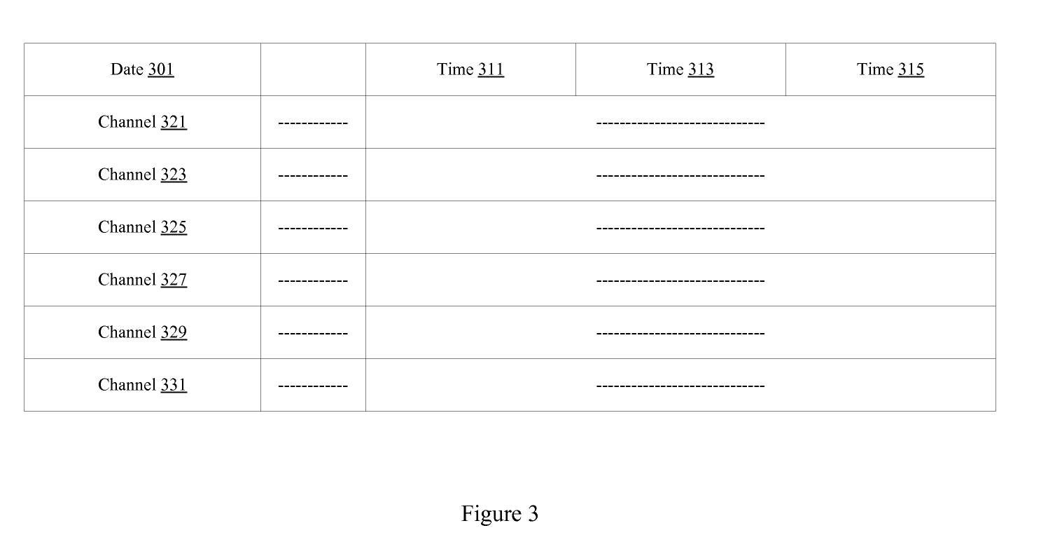

FIG. 3 is an exchange diagram depicting one example of program guide structure information. In some examples, the times 311, 313, and 315 cover a time range from time 311 through time 315, such as 3 pm to 5 pm. The program guide structure information provides information identifying channels 321, 323, 325, 327, 329, and 331. In some examples, program guide structure information includes a table of hundreds of channels. According to various embodiments, the program guide is ordered based on real-time determined popularity of programs. That is, the program guide is ordered based on the number of users watching a particular program at that particular time. A program guide can be created by a guide generator from information provided by a variety of content providers and compiled from a number of different users. The program guide structure information may include a listing of channels and not program guide content information for hundreds or thousands of channels.

Available systems download program guide information for all available channels or substantially all subscribed channels. In many instances, an entire program guide is downloaded. Downloading an entire program guide can take an unreasonably long period time, use considerable bandwidth, and consume resources on a device. For mobile devices with media capabilities operating in wireless networks, it is contemplated that it is beneficial to download program guide structure to allow a user to begin navigating while downloading program guide content dynamically based on demand from a user. In some examples, program guide content is downloaded in blocks with the most popular content downloaded first.

The program guide content block size may be determined based on the size of available mobile device memory. In another alternative, a program guide information block size is based upon data transmission rates, server cache block sizes, or available bandwidth. A wide variety of criteria and combinations of criteria can be used in determining a program guide information block size. In other examples, just enough data is downloaded to display a list and allow a user to begin to navigate the program guide information. As the user views different parts of the guide, the detailed content of the guide is downloaded separately and displayed as needed. There is no need to download the entire guide. Only what the user needs to view is downloaded on demand. Potentially limitless guide data can be downloaded in this manner. The user gets immediate feedback and does not need to wait for the data. The guide is not limited to the memory storage on the device or the service bandwidth. Guide data can be constantly updated since only the visible portion needs to be downloaded.

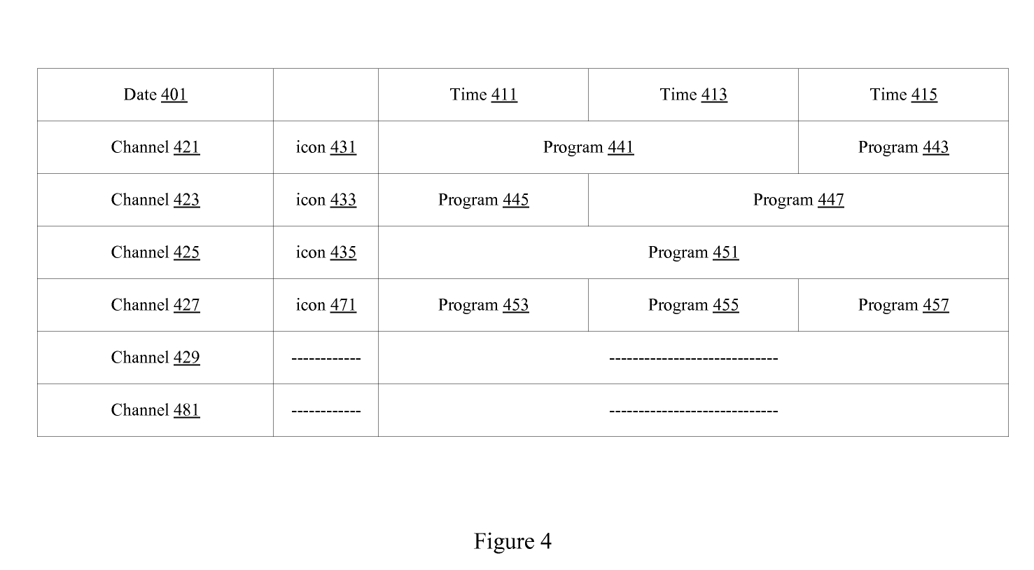

FIG. 4 depicts program guide structure information and program guide content information. In one example, program guide structure such as a listing of channels or at least a partial listing of channels is initially downloaded to allow a user to begin navigating. The block of program guide content information is associated with date 401 and times 411, 413, and 415. In another example, the times 411, 413, and 415 cover a time range from time 411 through time 415, such as 3 pm to 5 pm. Programs 441, 443, 445, 447, 451, 453, 455, and 457 are included in the program guide information block. The program guide information block shows program guide information for channels 421, 423, 425, 427, 429, and 481. In some examples, a program guide includes information for thousands of channels and video clips. A program guide can be created by a guide generator from information provided by a variety of content providers and from viewership information. Program guide structure information can be unique to each user. According to various embodiments, program guide content information is maintained in relatively generic form and can be cached on a server.

In some examples program guide content information only provides information for channels 421, 423, 425, and 427 and not for hundreds or thousands of other channels. The channels 421, 423, 524, and 427 may corresponding to channels carrying the most watched content at a particular time. A mobile device screen may only be sufficient to display a portion of the program guide information block. For example, the mobile device screen may only show information for channels 421, 423, and 425. Nonetheless, some extra information may be downloaded in anticipation of a user requesting that information. Although the channels shown are contiguous, it should be noted that channels and times as well do not have to be contiguous.

In some examples, a media content delivery server can remember channels or groups of channels frequently accessed by a user and provide the channels or groups of channels as part of a block of program guide information. In another example, a media content delivery server can recognize that a user typically views about a dozen or so popular channels and provide several pages of scroll down program guide information to a user preemptively even before the user performs any scrolling. In still other examples, a media content delivery server can recognize user viewing or listening patterns and download blocks of program guide content information believed to be of interest to a user. Similarly, a media content delivery server can determine times when media is frequently accessed and provide blocks of program guide information based on viewing times. A wide variety of algorithms can be implemented to intelligently select portions of program guide content information for download to a mobile device without having to download the entire program guide. Resources can be conserved while still providing the user with an active and dynamic experience.

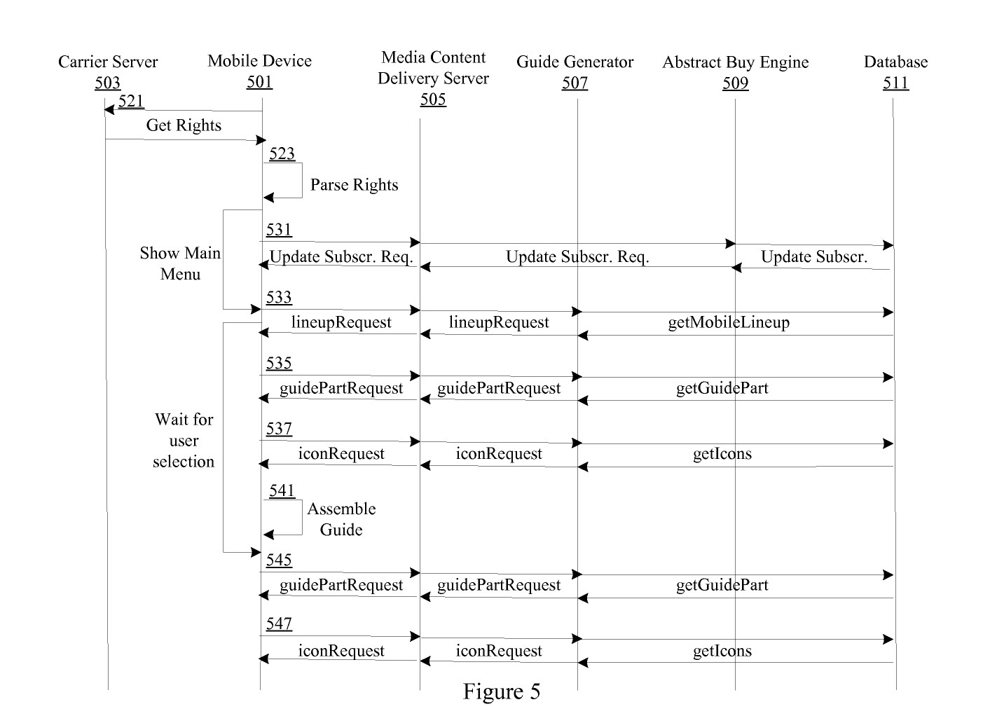

FIG. 5 is an exchange diagram showing one example of a mobile guide delivery sequence. A mobile device 501 obtains subscription service rights information from a carrier server 503. According to various embodiments, the mobile device parses and displays information associated with the rights at 523. In one example, a root menu showing subscribed and available channels is shown.

According to various embodiments, the mobile device 501 sends an update subscriptions request message at 531 to a media content delivery server 505. The media content delivery server 505 forwards the update subscriptions request message to an abstract buy engine 509. The abstract buy engine 509 sends an update subscriptions message to the database 511. The mobile device 501 also sends a lineup request message 535 to the media content delivery server 505. The lineup request message is forwarded to a guide generator 507. The guide generator obtains a lineup for the mobile device from the database 511. The abstract buy engine 509 is not involved in this particular request transaction. At 535, the mobile device sends a guide part request to the media content delivery server 505. In some examples, the request is a request for the entire program guide. In typical examples, the request is a request for a portion of the guide or a program guide information block. The program guide information block request is forwarded to a guide generator 507. The guide generator obtains the guide part from a database 511 or generates it based on other information.

In some examples, icons are also requested by the mobile device 501 at 537. The mobile device 501 sends an icon request to the media content delivery server 505. The media content delivery server 505 forwards the icon request to the guide generator 507. The guide generator obtains icons from the database 511. According to various embodiments, other information such as advertisements and media clips are also requested or provided along with the icons. At 541, the guide is assembled at the mobile device 501. According to various embodiments, the most popular real-time content is shown and display first. The user can then scroll through the guide or jump to a particular location in the guide. Some portions of the guide may not yet be downloaded. Consequently, additional guide part requests and icon requests may be sent by a mobile device 501 at 545 and 547. The additional program guide information block requests and icon requests at 545 and 547 may be sent for different channels, different channel blocks, or different time periods.

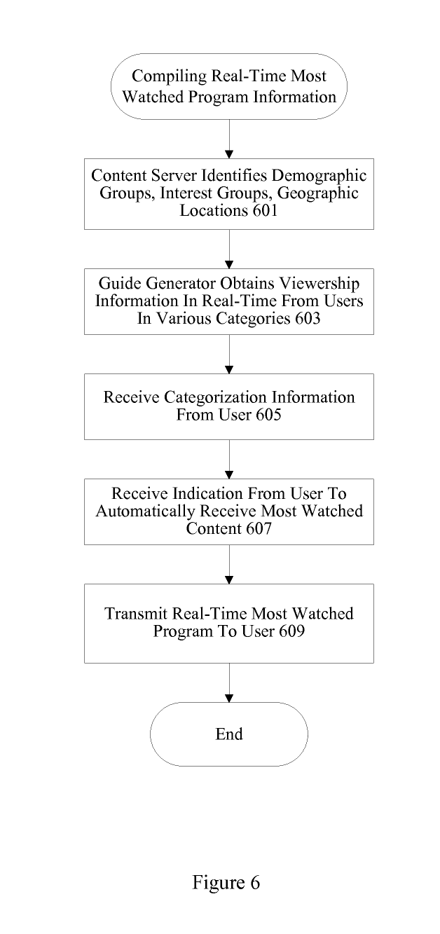

FIG. 6 is a flow process diagram showing one example of a technique for compiling real-time most watched program information. At 601, a content server identifies demographic groups, interest groups, and locations that can operate as categories for most watched content. For example, a content server may identify sports fans, investors, city residents, retirees, fashionistas, etc. as potential categories. According to various embodiments, a content server determines in real-time programming most watched by members of each category as well as for members in a particular location or all members in general. Viewers identify themselves as members of multiple categories. For example, a member may be both a sports fan and a retiree.

According to various embodiments, a content server determines at 603 real-time most watched content for users in each category as well as users in general. In particular embodiments, sports fans may be watching a basketball game while investors may be watching an financial news program. Users in general may be watching a sitcom. A variety of categories and demographic profiles can be used to categorize most-watched content. In other examples, categories and demographic profiles can be used to categorize content with the highest growth rates in viewership. According to various embodiments, a content server receives categorization information from a user at 605. For example, a content server may indicate interest in reality television, residency in the San Francisco Bay Area, and a love of food. A user may also indicate a preference to automatically watch whatever program is most watched by San Francisco Bay Area residents. Alternatively, the user may indicate a preference to automatically watch whatever program is most watched by all viewers in general. At 607, the content server receives an indication from a user to automatically receive most watched content. In some examples, this may be part of a default configuration of a media player. At 609, a real-time most-watched program is transmitted to the user.

According to various embodiments, the program guide can also be provided. A program guide can be continuously updated and reordered based on viewership information. In particular embodiments, a simple numerical ranking is sent as updates to individual users. The rankings allow individual client devices to order channels and video clips in an order desired. In still other embodiments, only a subset of the most popular programs are ranked. Other video content can still be provided in channel based numerical order. For example, the real-time most popular video content can be provided as a first page of a program guide. The entire program guide can be provided below are most watched section.

According to particular embodiments, the real-time most watched electronic program guide is provided to client devices and displayed in order of real-time popularity. Real-time most watched electronic program guide content can be provided before least watched electronic program guide content. In other examples, content can be automatically provided to a user based on content rated as most watched or content having the highest rate of viewership increase. The content may be general content or selected from a particular category identified by the user.

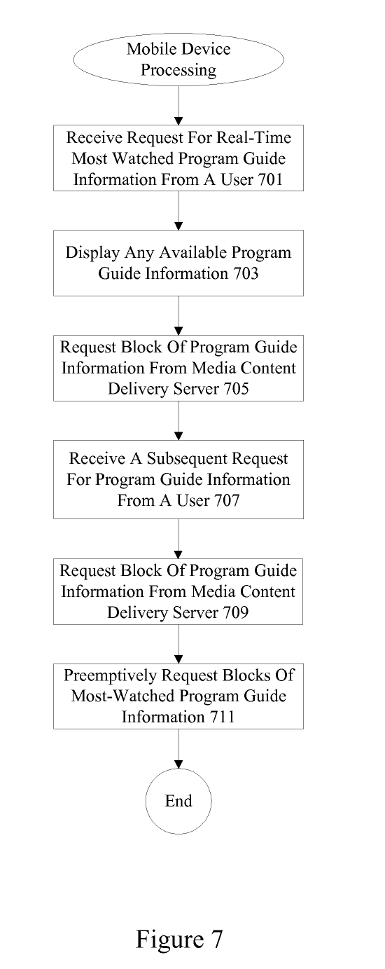

FIG. 7 is a flow process diagram showing one example of a request for media content. At 701, category and interest information is received from a user. The category and interest information may include a demographic profile, personal preference information, personal interests, etc. At 703, preference information is received from a user. According to various embodiments, preference information may indicate that a user wishes to automatically receive content that is currently being viewed by the largest number of viewers interested in drama or sports. Alternatively, preference information may indicate that a user wishes to automatically receive content that is currently increasing at the greatest rate in popularity for people from a particular location. In still other examples, the preference information may indicate that a user wishes to automatically receive a program guide ordered based on rates of increase in popularity for a particular category.

At 705, category, interest, and preference information is transmitted to a content server. In particular embodiments, the content server stores the information for the particular user. In some instances, the content server may also maintain a default profile if no information is received from a user. At 707, a request is received from content. In particular embodiments, the request is associated with a user profile that indicates a preference to receive content that has the highest increase in the rate of viewership in the last 15 minutes. The request is transmitted to the content server at 709. At 711, the content is received from the content server and automatically provided to the user on a media output device such as a display on a client device. A variety of client devices can be used. According to various embodiments, a client device includes a display, a processor, memory, an interface operable to communicate with a media content delivery server, and an input interface operable to allow a user to operate the device. Possible client devices include cellular phones, personal digital assistants, portable computing devices, etc.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method, comprising:
receiving real-time video content requests at a server from a plurality of client devices;
compiling real-time most watched program information;
receiving a request from a client device to automatically receive real-time most watched programming;
transmitting a program to the client device automatically selected using the real-time most watched program information.

2. The method of claim 1, wherein the program is a real-time most watched program.

3. The method of claim 1, wherein the program is content having the highest rate of increase in viewership.

4. The method of claim 1, wherein the real-time most watched program information is used to generate custom program guides for a plurality of client devices.

5. The method of claim 1, wherein the real-time most watched program information is used to generate custom program guides listing program having the highest rate of increase in viewership.

6. The method of claim 1, wherein real-time video content requests received at the server allow the server to determine a rate of change in viewership for a plurality of programs.

7. The method of claim 1, wherein real-time video content requests received at the server allow the server to determine a rate of change in network conditions associated with the plurality of client devices.

8. The method of claim 1, wherein real-time most watched program information is compiled for a plurality of categories.

9. The method of claim 1, wherein the real-time most watched program transmitted to the client device is the real-time most watched program for a particular demographic profile.

10. The method of claim 1, wherein the plurality of categories include interest categories and geographic location categories.

11. The method of claim 1, wherein the plurality of categories include network condition and content history categories.

12. The method of claim 1, wherein the real-time most watched program for a geographic location is transmitted to the client device.

13. The method of claim 1, wherein the real-time most watched program for members of a particular category is transmitted to the client device.

14. A system, comprising:
an interface operable to receive real-time video content requests at a server from a plurality of client devices, wherein the interface is further operable to receive a request from a client device to automatically receive real-time most watched programming;
a processor operable to compile real-time most watched program information;
wherein a program is automatically selected using real-time most watched program information and transmitted to the client device.

15. The system of claim 14, wherein real-time most watched program information is compiled for a plurality of categories.

16. The system of claim 14, wherein the real-time most watched program transmitted to the client device is the real-time most watched program for a particular category.

17. The system of claim 14, wherein the plurality of categories include interest categories and geographic location categories.

18. The system of claim 14, wherein the real-time most watched program for a geographic location is transmitted to the client device.

19. The system of claim 14, wherein the real-time most watched program for a particular demographic profile is transmitted to the client device.

20. An apparatus, comprising:
means for receiving real-time video content requests at a server from a plurality of client devices;
means for compiling real-time most watched program information;
means for receiving a request from a client device to automatically receive real-time most watched programming;
means for a transmitting a program to the client device, wherein the program is automatically selected using the real-time most watched program information.
